(19) United States
(12) Patent Application Publication
(10) Pub. No.: US 2011/0116454 A1
(43) Pub. Date: May 19, 2011

(54) SEMI-PERSISTENT SCHEDULING FOR MULTI-CARRIER WIRELESS COMMUNICATION

(75) Inventors: Wanshi Chen, San Diego, CA (US); Juan Montojo, San Diego, CA (US)

(73) Assignee: QUALCOMM INCORPORATED, San Diego, CA (US)

(21) Appl. No.: 12/772,918

(22) Filed: May 3, 2010

Related U.S. Application Data
(60) Provisional application No. 61/175,433, filed on May 4, 2009.

(51) Int. Cl. H04W 72/04

(52) U.S. Cl. 370/329

(57) ABSTRACT

Certain embodiments of the present disclosure present methods for semi-persistent scheduling (SPS) for multi-carrier wireless communications systems. The proposed methods support activation and release of one or more SPS services in any subframe for a given user configured with a plurality of carriers.

### CLAIM OF PRIORITY UNDER 35 U.S.C. §119

The present Application for Patent claims benefit of U.S. Provisional Patent Application Ser. No. 61/175,433, entitled, “Semi-Persistent Scheduling for Multi-Carrier Wireless Communication,” filed May 4, 2009, and assigned to the assignee hereof and hereby expressly incorporated by reference herein.

### TECHNICAL FIELD

Certain aspects of the present disclosure generally relate to wireless communications and more particularly, to systems and methods for semi-persistent scheduling in a multi-carrier wireless communication system.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input-single-output, multiple-input-single-output or a multiple-input-multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

### SUMMARY

Certain aspects of the present disclosure provide a method for wireless communications. The method generally includes configuring an apparatus to utilize a plurality of carriers, identifying a set of carriers of the plurality of carriers to be used for semi-persistent scheduling (SPS), and transmitting at least one SPS assignment on the set of carriers.

Certain aspects provide an apparatus for wireless communications. The apparatus generally include means for configuring another apparatus to utilize a plurality of carriers, means for identifying a set of carriers of the plurality of carriers to be used for semi-persistent scheduling (SPS), and means for transmitting at least one SPS assignment on the set of carriers.

Certain aspects provide an apparatus for wireless communications. The apparatus generally includes a first circuit configured to configure another apparatus to utilize a plurality of carriers, a second circuit configured to identifying a set of carriers of the plurality of carriers to be used for semi-persistent scheduling (SPS), and a transmitter configured to transmit at least one SPS assignment on the set of carriers.

Certain aspects provide a computer-program product for wireless communications comprising a computer readable medium having instructions stored thereon, the instructions being executable by one or more processors. The instructions generally include instructions for configuring an apparatus to utilize a plurality of carriers, instructions for identifying a set of carriers of the plurality of carriers to be used for semi-persistent scheduling (SPS), and instructions for transmitting at least one SPS assignment on the set of carriers.

Certain aspects provide an apparatus for wireless communications. The apparatus generally includes at least one processor configured to configure another apparatus to utilize a plurality of carriers, identify a set of carriers of the plurality of carriers to be used for semi-persistent scheduling (SPS), and transmit at least one SPS assignment on the set of carriers, and a memory coupled to the at least one processor.

Certain aspects of the present disclosure provide a method for wireless communications. The method generally includes receiving a configuration for utilizing a plurality of carriers, obtaining identification about a set of carriers of the plurality of carriers to be used for semi-persistent scheduling (SPS), and receiving, according to the configuration, at least one SPS assignment on the set of carriers.

Certain aspects provide an apparatus for wireless communications. The apparatus generally includes means for receiving a configuration for utilizing a plurality of carriers, means for obtaining an identification about a set of carriers of the plurality of carriers to be used for semi-persistent scheduling (SPS), and means for receiving, according to the configuration, at least one SPS assignment on the set of carriers.

Certain aspects provide an apparatus for wireless communications. The apparatus generally includes a receiver configured to receive a configuration for utilizing a plurality of carriers, a circuit configured to obtain an identification about a set of carriers of the plurality of carriers to be used for semi-persistent scheduling (SPS), wherein the receiver is also configured to receive, according to the configuration, at least one SPS assignment on the set of carriers.

Certain aspects provide a computer-program product for wireless communications comprising a computer readable medium having instructions stored thereon, the instructions being executable by one or more processors. The instructions generally include instructions for receiving a configuration for utilizing a plurality of carriers, instructions for obtaining an identification about a set of carriers of the plurality of carriers to be used for semi-persistent scheduling (SPS), and instructions for receiving, according to the configuration, at least one SPS assignment on the set of carriers.

Certain aspects provide an apparatus for wireless communications. The apparatus generally includes at least one processor configured to receive a configuration for utilizing a plurality of carriers, obtain an identification about a set of carriers of the plurality of carriers to be used for semi-persistent scheduling (SPS), and receive, according to the configuration, at least one SPS assignment on the set of carriers, and a memory coupled to the at least one processor.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system in accordance with certain aspects of the present disclosure.

FIG. 2 illustrates a block diagram of a communication system in accordance with certain aspects of the present disclosure.

FIG. 3 illustrates an example wireless communication system in accordance with certain aspects of the present disclosure.

FIGS. 4A-4C illustrate examples of independent control signaling across carriers in accordance with certain embodiments of the present disclosure.

FIG. 5 illustrates a table of possible combinations of semi-persistent scheduling (SPS) and dynamic assignments over two carriers in accordance with certain embodiments of the present disclosure.

FIGS. 6A-6C illustrate examples of joint control signaling across carriers, in accordance with certain embodiments of the present disclosure.

FIG. 7 illustrates example operations for semi-persistent scheduling for multicarrier wireless communications in accordance with certain embodiments of the present disclosure.

FIG. 7A illustrates example components capable of performing the operations illustrated in FIG. 7.

FIG. 8 illustrates example operations that may be performed at a user equipment side in accordance with certain embodiments of the present disclosure.

FIG. 8A illustrates example components capable of performing the operations illustrated in FIG. 8.

### DETAILED DESCRIPTION

Various aspects are now described with reference to the drawings. In the following description, for purposes of explanation, numerous specific details are set forth in order to provide a thorough understanding of one or more aspects. It may be evident; however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

### An Example Wireless Communication System

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), IEEE 802.11, IEEE 802.16, IEEE 802.20, Flash-OFDM®, etc. UTRA, E-UTRA and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

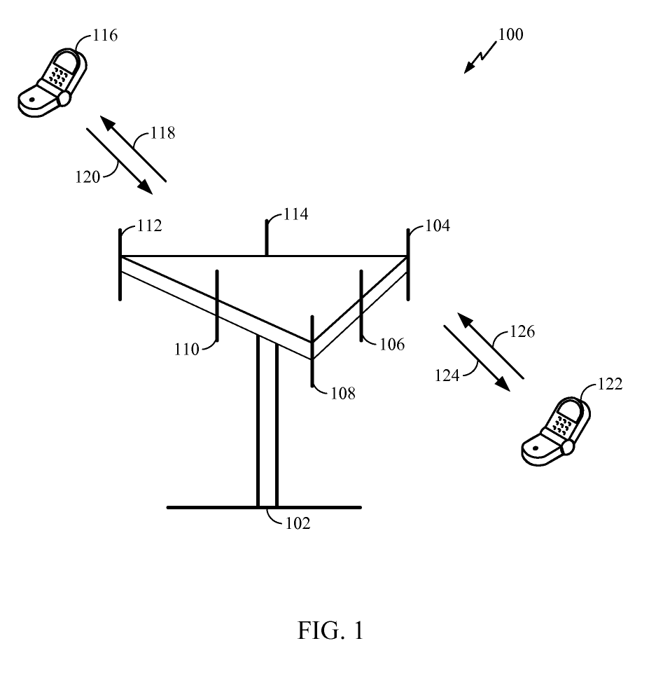

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In an FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

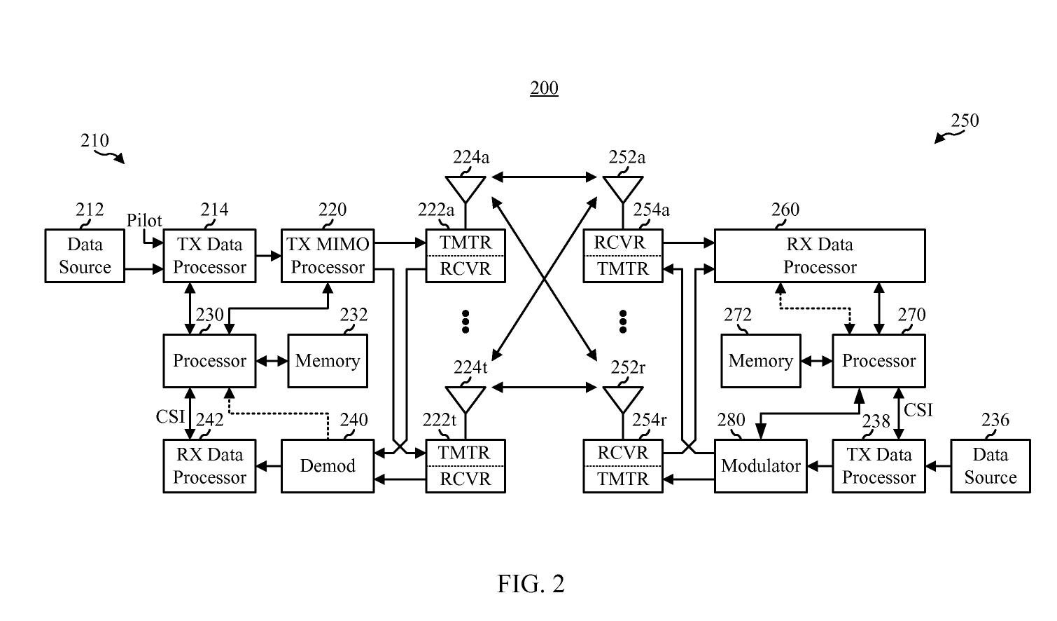

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250. Processor 230 then determines which pre-coding matrix to use for determining the beamforming weights then processes the extracted message.

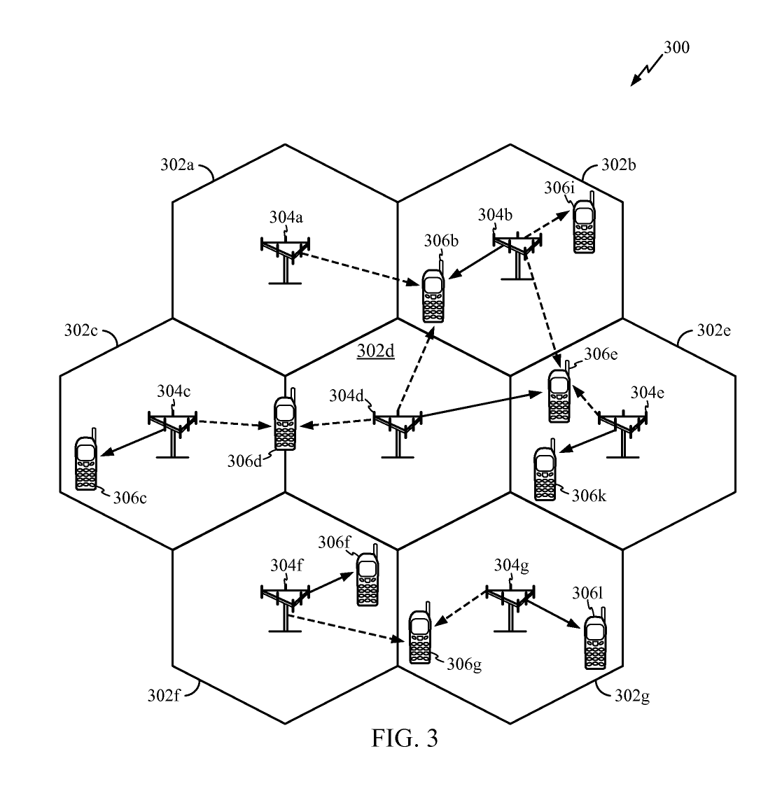

FIG. 3 illustrates an example wireless communication system 300 configured to support a number of users, in which various disclosed embodiments and aspects may be implemented. As shown in FIG. 3, by way of example, system 300 provides communication for multiple cells 302, such as, for example, macro cells 302a-302g, with each cell being serviced by a corresponding access point (AP) 304 (such as APs 304a-304g). Each cell may be further divided into one or more sectors (e.g., to serve one or more frequencies). Various access terminals (ATs) 306, including ATs 306a-306k, also known interchangeably as user equipment (UE) or mobile stations, are dispersed throughout the system.

Each UE 306 may communicate with one or more APs 304 on a forward link (FL) and/or a reverse link (RL) at a given moment, depending upon whether the UE is active and whether it is in soft handoff, for example. The wireless communication system 300 may provide service over a large geographic region, for example, macro cells 302a-302g may cover a few blocks in a neighborhood.

### Semi-Persistent Scheduling for Multi-Carrier Wireless Communication

Certain embodiments of the present disclosure support methods for semi-persistent scheduling (SPS) for multi-carrier wireless communications systems. The proposed methods support activation and release of one or more SPS services (assignments) in any subframe for a given user equipment (UE) configured with a plurality of carriers.

The present disclosure proposes methods for semi-persistent scheduling (SPS) for multi-carrier wireless communications systems. The proposed methods support one or more SPS services in any subframe for a given UE, by defining control signaling approach and downlink/uplink (DL/UL) carrier pairing.

In a wireless communication system, an evolved Node B (eNB) may allocate physical layer resources, such as physical resource blocks (PRB), and modulation and coding scheme (MCS) for uplink and downlink channels. The MCS may determine bit rate and capacity of PRBs. Allocations may be valid for one or more transmission time intervals (TTIs).

Semi-persistent scheduling (SPS) may reduce control channel signaling by letting the eNB to set up an ongoing allocation that persists until it is changed. Semi-persistent schedules may be configured for both uplink and downlink.

In release 8 (Rel-8) specification of the LTE wireless communication standard, DL SPS may be activated and re-configured via downlink control information (DCI) message with formats 1, 1A, 2 and 2A. To reduce the probability of false detection of SPS activation or reconfiguration, 6 bits (for frequency division duplex) or 7 bits (for time division duplex) in the corresponding DCI message may be set to zero in order to virtually increase the cyclic redundancy check (CRC) length from the nominal 16 bits to 22 or 23 bits. In addition, DL SPS may be released via DCI format 1A.

Traditionally, a user equipment (UE) may receive either a DL SPS assignment such as activation (e.g., persistent DL SPS transmissions), de-activation or a dynamically scheduled DL assignment in any subframe. The UE may not receive more than one of the aforementioned assignments simultaneously in any subframe. It should be noted that both DL SPS assignment/deactivation and dynamic DL assignment may require transmission of acknowledgement (ACK) or negative acknowledgement (NAK) from the UE. In the case of DL SPS release (deactivation), the UE may always transmit a positive ACK message.

Uplink SPS may also be activated or reconfigured via DCI format 0. Similar to the DL SPS, 6 bits in DCI format 0 may be set to zeros to virtually increase the CRC length from the nominal 16 bits to 22 bits. In addition, the UL SPS may be released via a DCI message with format 0. Similar to the downlink case, the UE may not receive two different assignments simultaneously in any subframe in a single carrier system.

For certain embodiments of the present disclosure, transmissions of SPS and dynamic scheduling assignments in a subframe for two or more carriers may be performed simultaneously. Two cases may be considered, such as independent transmissions of control signals across different component carriers, and joint control signaling across different component carriers.

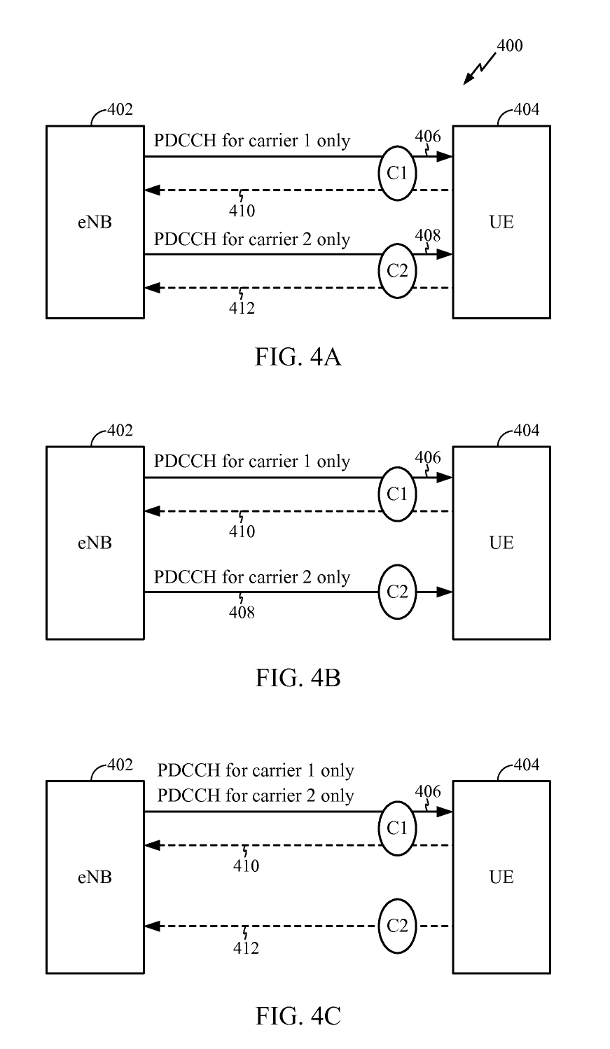

FIGS. 4A-4C illustrate examples of control signals transmitted independently across carriers, in accordance with certain embodiments of the present disclosure. The eNB 402 may transmit/receive signals to/from the UE 404.

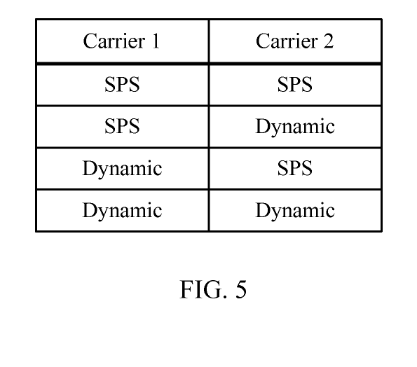

A symmetric DL/UL pairing is illustrated in FIG. 4A in which there may be a one-to-one DL and UL pairing when number of uplink and downlink carriers is equal. Each of the carriers, c1 and c2, may comprise both downlink 406-408 assignments and uplink 410-412 assignments. For two carriers, there may be four possible combinations of SPS services and dynamic assignments in any subframe in DL and UL channels, as illustrated in FIG. 5.

FIG. 5 illustrates a table of possible combinations of SPS and dynamic assignments over two carriers, in accordance with certain embodiments of the present disclosure. As illustrated, for two carriers (n=2), there may be four (e.g., 2ⁿ) possible combinations.

However, in order to reduce false detection instances, there may be some limitations on a total number of carriers that may simultaneously comprise SPS services. For example, if the total number of carriers is represented by N, the total number of carriers allowed for SPS services may be represented by M, in which 1≦M≦N. Therefore, if M=1 and N=2, only the last three combinations listed in FIG. 5 may be allowed. For certain embodiments, UL and DL may have different limitations in terms of the number of carriers that may have simultaneous SPS services.

In one embodiment, number of simultaneous SPS services in a subframe for a given UE may be strictly less than the number of active component carriers. In another embodiment, if more than one SPS assignment is configured over different component carriers, some or all of configuration properties such as SPS periodicity and discontinuous transmission (DTX) offset for different SPS assignments may be aligned to save battery at the UE. For instance, at least one of periodicity or the DTX offset for one of the carriers may be similar to another carrier, or they may be integer multiples of the other carrier (e.g., 10 ms vs. 20 ms).

In yet another embodiment, if L3 (network Layer 3) SPS configurations (e.g., periodicity) are similar for one or more carriers, activation and/or release of SPS for different carriers may share some or all of the control information, such as modulation and coding scheme. However, number of carriers that may be activated or released by transmissions in the Physical Downlink Control Channel (PDCCH) may need to be indicated to the UE.

FIGS. 4B-4C illustrate asymmetric downlink and uplink pairings for independent control signaling across carriers. As illustrated, downlink and uplink channels may be paired asymmetrically. For example, there may be more uplink channels than downlink channels (FIG. 4C), or there may be more downlink channels than uplink channels, as illustrated in FIG. 4B.

As illustrated in FIG. 4B, two carriers c1 and c2 may transmit downlink control information to the UE through PDCCHs 406-408, while there may be only one uplink channel 410. When there exist multiple DL channels with one UL channel, if unicast DL PDCCHs can be received simultaneously from two or more carriers by the UE, SPS and DL dynamic assignments may be transmitted to the UE simultaneously.

In some systems, there may be a limitation on the number of SPS instances per UL in a given period of time (e.g., a period t). For example, if only one SPS assignment is allowed per UL in t milliseconds, the SPS periodicity offset and activation or release may be coordinated among different carriers associated with the same UL, such that there may be only one activated SPS within any t period.

FIG. 4C illustrates asymmetric downlink and uplink pairing for independent control signaling across carriers with one DL and multiple UL channels. As illustrated, carrier c1 may be used for PDCCH transmissions for both c1 and c2 carriers. For dynamic UL assignments, the UE may decode two (or more) independent PDCCHs carrying UL assignments in one subframe in one DL carrier.

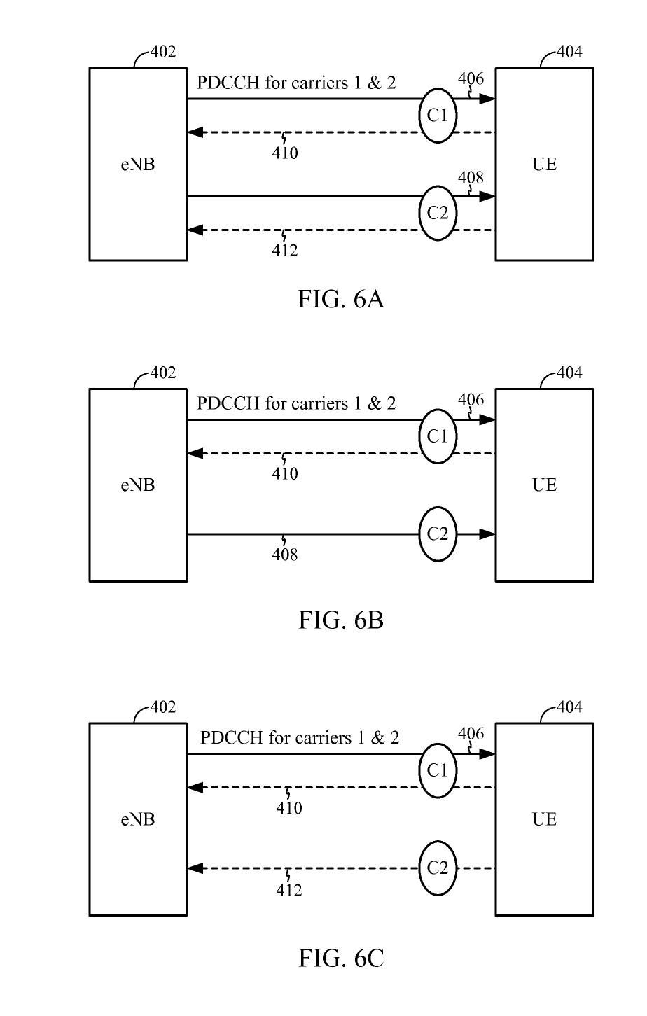

FIGS. 6A-6C illustrate examples of joint control signaling across carriers, in accordance with certain embodiments of the present disclosure. FIG. 6A illustrates symmetric DL/UL pairing with joint DL control signaling on carrier c1 for uplink transmissions on carriers c1 and c2. FIGS. 6B and 6C illustrate asymmetric DL/UL pairing across two carriers.

Similar aforementioned principles may apply to the examples illustrated in FIGS. 6A-6C. If there are multiple DL with one UL channels, as in FIG. 6B, it may be possible to configure one DL SPS with persistent resource spanning over two or more DL carriers (at the same slot, or over two slots in one subframe), in order to improve transmit diversity and increase flexibility.

Similarly, for one DL and multiple UL channels, as illustrated in FIG. 6C, it may be possible to configure one UL SPS with persistent resource spanning over two or more UL carriers (at the same slot, or over two slots in one subframe), in order to improve transmit diversity and increase flexibility.

The L3 network layer may configure up to four Acknowledgement/Negative Acknowledgement (ACK/NAK) resources for DL SPS, while in PDCCH, two bits may be utilized to indicate which one of the four ACK/NAK resources may be used for this activation. This may be done by reusing the two bits of PUCCH transmit power control (TPC) command field.

For certain embodiments, ACK/NAK resource indexing for DL SPS under multi-carrier may require special treatment when only one TPC command information field is available for transmission in PUCCH. In particular, if only two bits are used to indicate ACK/NCK resource indices (as in Rel-8) for two or more DL SPS assignments, the other carriers may have their resource indices with a configurable or hardcoded offset relative to the set of resource indices of the first DL SPS.

If two or more SPS services are activated at the same time, it may be necessary to borrow some bits (e.g., multiples of two bits) for the second SPS carrier and beyond. Alternatively, the two bits may be interpreted as follows. Total number of semi-persistent resources may be represented by N_{PUCCH}⁽¹⁾. Four resources configured by L3 for the first component carrier may be represented by indexes n_{PUCCH,1,1}⁽¹⁾, n_{PUCCH,1,2}⁽¹⁾, n_{PUCCH,1,3}⁽¹⁾, and n_{PUCCH,1,4}⁽¹⁾. For certain embodiments, if the second carrier is activated at the same time, the four resources for the second carrier may be determined as a function of the total number of semi-persistent resources and the index of the first resource allocated to the first carrier as follows:

n_{PUCCH,2,1}⁽¹⁾=ƒ(n_{PUCCH,1,1}⁽¹⁾, n_{PUCCH}⁽¹⁾)

For example, the function ƒ may be a modulus function, such as n_{PUCCH,2,1}⁽¹⁾=mod(n_{PUCCH,1,1}⁽¹⁾+1,N_{PUCCH}⁽¹⁾), which means that the set of resource indexes for the second carrier may have an offset relative to the set of resource indexes of the first carrier. The offset value may be configured for each UE, for each cell, or may be defined in standard specifications. For certain embodiments, the offset may also be determined based on cell identification, carrier index, and other parameters

A UE may derive, based on one or more bits of a received Physical Downlink Control Channel (PDCCH) block, an index of an ACK/NAK resource from a plurality of ACK/NAK resources that are configured to indicate SPS activation of a carrier from a set of carriers configured for SPS. The UE may indicate the activation of the carrier using the ACK/NAK resource with the derived index. After that, the UE may be deriving, based on the index and a total number of SPS resources, one or more other indexes of one or more other ACK/NAK resources. Then, the UE may be indicating SPS activation of at least one other carrier from the set using the one or more other ACK/NAK resources with the derived one or more other indexes.

Upon releasing DL SPS, the UE may send a positive ACK using the ACK/NAK resource mapped from the lowest control channel element (CCE) of the corresponding PDCCH channel. For certain embodiments, if multiple SPS releases are received, the UE may send the ACK messages for all SPS releases jointly in one subframe. The joint encoding may be more applicable for the case of asymmetric configuration in which a number of carriers used for downlink transmissions is larger than the number of carriers used for uplink.

For example, for a configuration with N DL carriers and one uplink carrier, instead of sending ACK for each DL SPS individually, the UE may use PUCCH format 1a or 1b to indicate release of up to two or up to four carriers, respectively. The eNB may be receiving at least one ACK transmitted from the UE indicating releasing of two or more carriers.

For certain embodiments, if two or more SPS carriers are activated or deactivated simultaneously in one subframe, one PDCCH block may be addressing two or more SPS carriers. One or more fields of the PDCCH block may be common for the two or more SPS carriers, while each of one or more other fields of the PDCCH block may be specific to each individual (different) carrier.

For certain embodiments, if two or more SPS carriers are activated or deactivated simultaneously in one subframe, individual PDCCH transmissions may be used for each of the carriers, and a total number of SPS carriers that are being activated or deactivated may be indicated to the UE within each PDCCH (or for an anchor PDCCH only) either explicitly or implicitly. The UE may then detect, from the PDCCH block, the indication about a number of carriers being simultaneously activated or deactivated.

Multiple PDCCH activations or deactivations in one subframe may be transmitted to the UE either jointly or individually. In case of individual transmissions, total number of SPS activations or deactivations may be embedded in the anchor carrier SPS or in all the SPS assignments to increase reliability of the system.

If there is at least one carrier scheduled for SPS activation, and at the same time, at least one other carrier scheduled for deactivation from SPS services, then an indication about the deactivation may be embedded into one or more of the activation PDCCH blocks. In other words, indications about the SPS activation and deactivation may be jointly transmitted. The UE may be then able to detect an embedding indication about the deactivation, wherein the indication may be embedded into one or more of received PDCCH blocks addressing the activation.

For certain embodiments, if two or more SPS carriers are activated or deactivated simultaneously in one subframe, either one SPS cell radio network temporary identification (C-RNTI) may be defined for all carriers, or one SPS C-RNTI for each carrier.

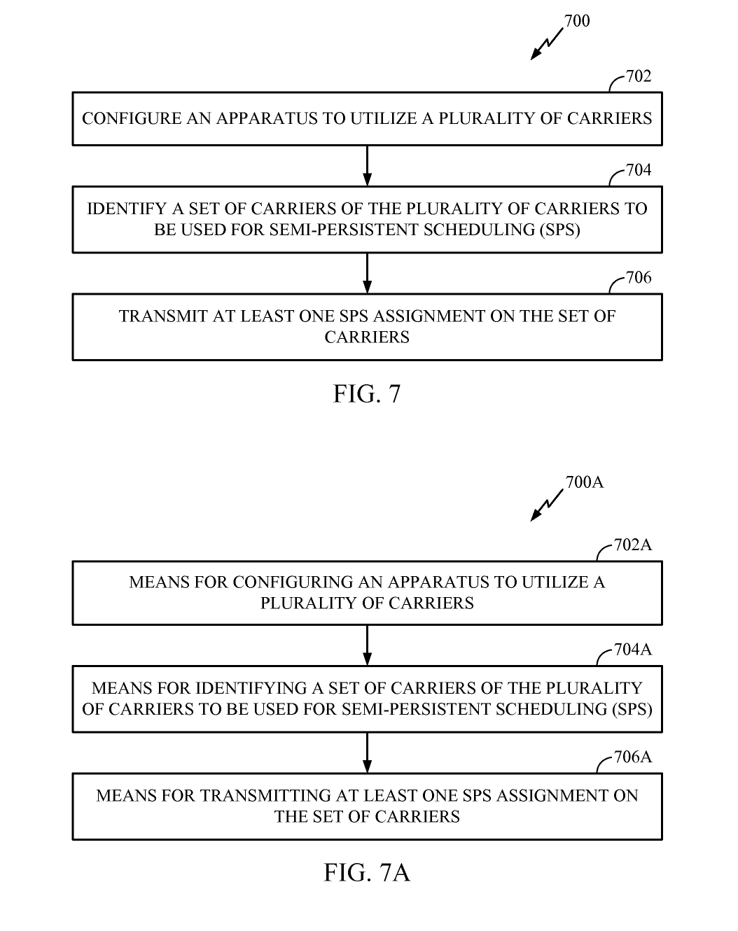

FIG. 7 illustrates example operations 700 for semi-persistent scheduling for multicarrier wireless communications that may be performed at an eNB in accordance with certain embodiments of the present disclosure. At 702, the eNB may configure a UE to utilize a plurality of carriers. At 704, the eNB may identify a set of carriers of the plurality of carriers to be used for SPS. The set of carriers may comprise only one carrier or multiple carriers. The only one SPS carrier may correspond to a primary component carrier within the plurality of carriers. At 706, the eNB may transmit at least one SPS assignment on the set of carriers. In a subframe, a first set of the carriers used for transmitting the SPS assignments and a second set of the carriers used for transmitting dynamic scheduling assignments may not comprise any common carriers. The eNB may scramble both control and data transmissions of the at least one SPS assignment using an SPS specific identifier of the UE.

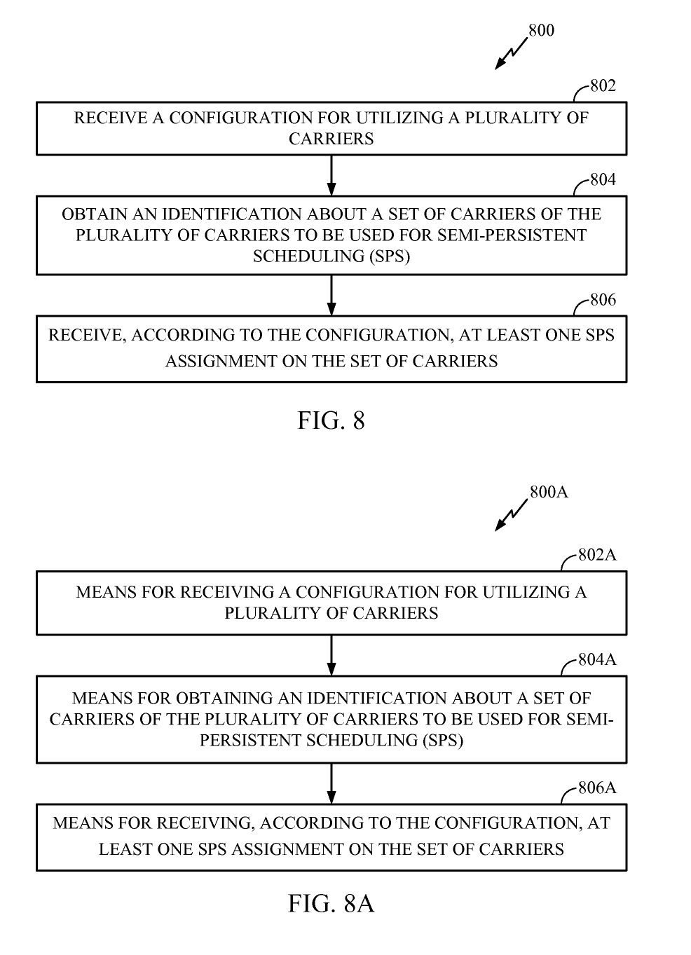

FIG. 8 illustrates example operations 800 that may be performed at a UE in accordance with certain embodiments of the present disclosure. At 802, the UE may receive a configuration for utilizing a plurality of carriers. At 804, the UE may obtain an identification about a set of carriers of the plurality of carriers to be used for SPS. At 806, the UE may receive, according to the configuration, at least one SPS assignment on the set of carriers. It should be noted that response messages to the SPS assignments may share at least some control information.

Certain embodiments of the present disclosure presented methods for semi-persistent scheduling (SPS) for multi-carrier wireless communications systems. The proposed methods support one or more SPS services in any subframe for a given UE, by defining control signaling approach and DL/UL carrier pairing.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, operations 700 and 800 illustrated in FIGS. 7 and 8 correspond to components 700A and 800A illustrated in FIGS. 7A and 8A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
configuring an apparatus to utilize a plurality of carriers;
identifying a set of carriers of the plurality of carriers to be used for semi-persistent scheduling (SPS); and
transmitting at least one SPS assignment on the set of carriers.

2. The method of claim 1, wherein:
the set of carriers comprises only one carrier, and
the carrier comprises a primary component carrier within the plurality of carriers.

3. The method of claim 1, wherein, in a subframe, a first set of the carriers used for transmitting the SPS assignments and a second set of the carriers used for transmitting dynamic scheduling assignments do not comprise any common carriers.

4. The method of claim 3, wherein the set of carriers comprises the first set of carriers.

5. The method of claim 1, further comprising:
scrambling both control and data transmissions of the at least one SPS assignment using an SPS specific identifier of the apparatus.

6. The method of claim 1, further comprising:
transmitting a Physical Downlink Control Channel (PDCCH) block comprising bits that determine which one of Acknowledgement/Negative Acknowledgement (ACK/NAK) resources is to be used for indicating SPS activation of a carrier from the set,
wherein one or more indexes of one or more other ACK/NAK resources configured for indicating SPS activation of one or more other carriers from the set are based on one or more indexes of one or more of the ACK/NAK resources and on a total number of SPS resources.

7. The method of claim 1, further comprising:
receiving at least one Acknowledgement (ACK) transmitted from the apparatus indicating releasing of two or more carriers from the set.

8. The method of claim 1, further comprising:
for simultaneous SPS activation or deactivation in one subframe of two or more carriers from the set, transmitting a Physical Downlink Control Channel (PDCCH) block addressing the two or more carriers, wherein one or more fields of the PDCCH block are common for the two or more carriers, and wherein each of one or more other fields of the PDCCH block is allocated to a different carrier of the two or more carriers.

9. The method of claim 1, further comprising:
for simultaneous SPS activation or deactivation in one subframe of two or more carriers from the set, transmitting a Physical Downlink Control Channel (PDCCH) block addressing each of the two or more carriers, wherein each of the PDCCH blocks comprises an indication about a number of the two or more carriers.

10. The method of claim 1, further comprising:
for SPS activation of at least one carrier from the set and simultaneous deactivation of at least one other carrier from the set, embedding an indication about the deactivation into one or more Physical Downlink Control Channel (PDCCH) blocks addressing the SPS activation.

11. An apparatus for wireless communications, comprising:
means for configuring another apparatus to utilize a plurality of carriers;
means for identifying a set of carriers of the plurality of carriers to be used for semi-persistent scheduling (SPS); and
means for transmitting at least one SPS assignment on the set of carriers.

12. The apparatus of claim 11, wherein:
the set of carriers comprises only one carrier, and
the carrier comprises a primary component carrier within the plurality of carriers.

13. The apparatus of claim 11, wherein, in a subframe, a first set of the carriers used for transmitting the SPS assignments and a second set of the carriers used for transmitting dynamic scheduling assignments do not comprise any common carriers.

14. The apparatus of claim 13, wherein the set of carriers comprises the first set of carriers.

15. The apparatus of claim 11, further comprising:
means for scrambling both control and data transmissions of the at least one SPS assignment using an SPS specific identifier of the other apparatus.

16. The apparatus of claim 11, further comprising:
means for transmitting a Physical Downlink Control Channel (PDCCH) block comprising bits that determine which one of Acknowledgement/Negative Acknowledgement (ACK/NAK) resources is to be used for indicating SPS activation of a carrier from the set,
wherein one or more indexes of one or more other ACK/NAK resources configured for indicating SPS activation of one or more other carriers from the set are based on one or more indexes of one or more of the ACK/NAK resources and on a total number of SPS resources.

17. The apparatus of claim 11, further comprising:
means for receiving at least one Acknowledgement (ACK) transmitted from the apparatus indicating releasing of two or more carriers from the set.

18. The apparatus of claim 11, further comprising:
means for transmitting, for simultaneous SPS activation or deactivation in one subframe of two or more carriers from the set, a Physical Downlink Control Channel (PDCCH) block addressing the two or more carriers, wherein one or more fields of the PDCCH block are common for the two or more carriers, and wherein each of one or more other fields of the PDCCH block is allocated to a different carrier of the two or more carriers.

19. The apparatus of claim 11, further comprising:
means for transmitting, for simultaneous SPS activation or deactivation in one subframe of two or more carriers from the set, a Physical Downlink Control Channel (PDCCH) block addressing each of the two or more carriers, wherein each of the PDCCH blocks comprises an indication about a number of the two or more carriers.

20. The apparatus of claim 11, further comprising:
means for embedding, for SPS activation of at least one carrier from the set and simultaneous deactivation of at least one other carrier from the set, an indication about the deactivation into one or more Physical Downlink Control Channel (PDCCH) blocks addressing the SPS activation.

21. An apparatus for wireless communications, comprising:
a first circuit configured to configure another apparatus to utilize a plurality of carriers;
a second circuit configured to identifying a set of carriers of the plurality of carriers to be used for semi-persistent scheduling (SPS); and
a transmitter configured to transmit at least one SPS assignment on the set of carriers.

22. A computer-program product for wireless communications, comprising a computer readable medium having instructions stored thereon, the instructions being executable by one or more processors and the instructions comprising:
instructions for configuring an apparatus to utilize a plurality of carriers;
instructions for identifying a set of carriers of the plurality of carriers to be used for semi-persistent scheduling (SPS); and
instructions for transmitting at least one SPS assignment on the set of carriers.

23. An apparatus for wireless communications, comprising:
at least one processor configured to
configure another apparatus to utilize a plurality of carriers,
identify a set of carriers of the plurality of carriers to be used for semi-persistent scheduling (SPS), and
transmit at least one SPS assignment on the set of carriers; and
a memory coupled to the at least one processor.

24. A method for wireless communications, comprising:
receiving a configuration for utilizing a plurality of carriers;
obtaining an identification about a set of carriers of the plurality of carriers to be used for semi-persistent scheduling (SPS); and
receiving, according to the configuration, at least one SPS assignment on the set of carriers.

25. The method of claim 24, wherein:
the set of carriers comprises only one carrier, and
the carrier comprises a primary component carrier within the plurality of carriers.

26. The method of claim 24, wherein, in a subframe, a first set of the carriers used for receiving the SPS assignments and a second set of the carriers used for receiving dynamic scheduling assignments do not comprise any common carriers.

27. The method of claim 26, wherein the set of carriers comprises the first set of carriers.

28. The method of claim 24, wherein response messages to the SPS assignments share at least some control information.

29. The method of claim 24, further comprising:
deriving, based on one or more bits of a received Physical Downlink Control Channel (PDCCH) block, an index of an Acknowledgement/Negative Acknowledgement (ACK/NAK) resource from a plurality of ACK/NAK resources that are configured to indicate SPS activation of a carrier from the set;
indicating the SPS activation of the carrier using the ACK/NAK resource with the derived index;
deriving, based on the index and a total number of SPS resources, one or more other indexes of one or more other ACK/NAK resources; and
indicating SPS activation of at least one other carrier from the set using the one or more other ACK/NAK resources with the one or more other indexes.

30. The method of claim 24, further comprising:
transmitting at least one Acknowledgement (ACK) to indicate releasing of two or more carriers from the set.

31. The method of claim 24, further comprising:
receiving, when two or more carriers from the set are to be simultaneously activated or deactivated in one subframe, a Physical Downlink Control Channel (PDCCH) block addressing the two or more carriers,
wherein one or more fields of the PDCCH block are common for the two or more carriers, and wherein each of one or more other fields of the PDCCH block is allocated to a different carrier of the two or more carriers.

32. The method of claim 24, further comprising:
receiving, for each of two or more carriers from the set that are to be simultaneously activated or deactivated in one subframe, a Physical Downlink Control Channel (PDCCH) block addressing that carrier; and
detecting, from the PDCCH block, an indication about a number of the two or more carriers.

33. The method of claim 24, further comprising:
in case of SPS activation of at least one carrier from the set and simultaneous deactivation of at least one other carrier from the set, detecting an indication about the deactivation embedded into one or more of received Physical Downlink Control Channel (PDCCH) blocks addressing the SPS activation.

34. An apparatus for wireless communications, comprising:
means for receiving a configuration for utilizing a plurality of carriers;
means for obtaining an identification about a set of carriers of the plurality of carriers to be used for semi-persistent scheduling (SPS); and
means for receiving, according to the configuration, at least one SPS assignment on the set of carriers.

35. The apparatus of claim 34, wherein:
the set of carriers comprises only one carrier, and
the carrier comprises a primary component carrier within the plurality of carriers.

36. The apparatus of claim 34, wherein, in a subframe, a first set of the carriers used for receiving the SPS assignments and a second set of the carriers used for receiving dynamic scheduling assignments do not comprise any common carriers.

37. The apparatus of claim 36, wherein the set of carriers comprises the first set of carriers.

38. The apparatus of claim 34, wherein response messages to the SPS assignments share at least some control information.

39. The apparatus of claim 34, further comprising:
means for deriving, based on one or more bits of a received Physical Downlink Control Channel (PDCCH) block, an index of an Acknowledgement/Negative Acknowledgement (ACK/NAK) resource from a plurality of ACK/NAK resources that are configured to indicate SPS activation of a carrier from the set;
means for indicating the SPS activation of the carrier using the ACK/NAK resource with the derived index;
means for deriving, based on the index and a total number of SPS resources, one or more other indexes of one or more other ACK/NAK resources; and
means for indicating SPS activation of at least one other carrier from the set using the one or more other ACK/NAK resources with the one or more other indexes.

40. The apparatus of claim 34, further comprising:
means for transmitting at least one Acknowledgement (ACK) to indicate releasing of two or more carriers from the set.

41. The apparatus of claim 34, further comprising:
means for receiving, when two or more carriers from the set are to be simultaneously activated or deactivated in one subframe, a Physical Downlink Control Channel (PDCCH) block addressing the two or more carriers,
wherein one or more fields of the PDCCH block are common for the two or more carriers, and wherein each of one or more other fields of the PDCCH block is allocated to a different carrier of the two or more carriers.

42. The apparatus of claim 34, further comprising:
means for receiving, for each of two or more carriers from the set that are to be simultaneously activated or deactivated in one subframe, a Physical Downlink Control Channel (PDCCH) block addressing that carrier; and
means for detecting, from the PDCCH block, an indication about a number of the two or more carriers.

43. The apparatus of claim 34, further comprising:
means for detecting, in case of SPS activation of at least one carrier from the set and simultaneous deactivation of at least one other carrier from the set, an indication about the deactivation embedded into one or more of received Physical Downlink Control Channel (PDCCH) blocks addressing the SPS activation.

44. An apparatus for wireless communications, comprising:
a receiver configured to receive a configuration for utilizing a plurality of carriers;
a circuit configured to obtain an identification about a set of carriers of the plurality of carriers to be used for semi-persistent scheduling (SPS), wherein
the receiver is also configured to receive, according to the configuration, at least one SPS assignment on the set of carriers.

45. A computer-program product for wireless communications, comprising a computer readable medium having instructions stored thereon, the instructions being executable by one or more processors and the instructions comprising:
instructions for receiving a configuration for utilizing a plurality of carriers;
instructions for obtaining an identification about a set of carriers of the plurality of carriers to be used for semi-persistent scheduling (SPS); and
instructions for receiving, according to the configuration, at least one SPS assignment on the set of carriers.

46. An apparatus for wireless communications, comprising:
at least one processor configured to
receive a configuration for utilizing a plurality of carriers,
obtain an identification about a set of carriers of the plurality of carriers to be used for semi-persistent scheduling (SPS), and
receive, according to the configuration, at least one SPS assignment on the set of carriers; and
a memory coupled to the at least one processor.
